(19) United States
(12) Patent Application Publication
(10) Pub. No.: US 2013/0091321 A1
(43) Pub. Date: Apr. 11, 2013

(54) METHOD AND APPARATUS FOR UTILIZING NAND FLASH IN A MEMORY SYSTEM HIERARCHY

(71) Applicants: Satyanarayana Nishtala, Cupertino, CA (US); Pere Monclus, San Jose, CA (US)

(72) Inventors: Satyanarayana Nishtala, Cupertino, CA (US); Pere Monclus, San Jose, CA (US)

(73) Assignee: CISCO TECHNOLOGY, INC., San Jose, CA (US)

(21) Appl. No.: 13/270,442

(22) Filed: Oct. 11, 2011

(51) Int. Cl. G06F 12/00

(52) U.S. Cl. 711/103; 711/E12.008

(57) ABSTRACT

In one embodiment, a method includes obtaining a request for data, determining if the data is present in a physical memory, and obtaining the data from a non-volatile random access memory if it is determined that the data is not present in the physical memory. The request is obtained by an overall system that includes the physical memory and the non-volatile random access memory, and the overall system is configured to push information from the physical memory to the non-volatile random access memory.

The disclosure relates generally to a memory hierarchy of a computing system, and more particularly to enabling non-volatile random access memory to be accessed using semantics that effectively match those of volatile system memory.

### BACKGROUND

Many systems, e.g., computing systems, utilize physically addressable memory, or “physical memory,” to store information, e.g., instructions and temporary data. Physical memory such as DRAM may be accessed in relatively small chunks or blocks and, as such, access times associated with physical memory may be relatively low. For example, physical memory is typically accessed in 64 byte blocks with access times on the order of approximately 100 nanoseconds (ns). As memory requirements increase, the amount of physical memory needed is increasing. In many instances, providing enough physical memory to meet the requirements of a system may be impractical due to the cost of physical memory, the amount of space occupied by physical memory, and the power consumption requirements of physical memory. Often, a storage disk is provided such that data stored in physical memory may be swapped onto the storage disk and retrieved from the storage disk as needed. However, the latency associated with accessing a storage disk may be significantly longer than the latency associated with accessing a physical memory. By way of example, while access times associated with physical memory may be on the order of nanoseconds, the access times associated with a storage disk may be on the order of milliseconds. Thus, there is often a need to add physical memory to a computing system in order to achieve acceptable performance of applications that store instructions and data.

Non-volatile random access memory is generally of a lower cost than physical memory, occupies less space than physical memory, and has lower power consumption requirements than physical memory. However, non-volatile random access memory such as a NAND flash memory is generally accessed in relatively large chunks or blocks, as for example chunks or blocks with a size on the order of approximately 4 kilobytes (Kbytes) or approximately 8 Kbytes. Moreover the access times associated with accessing data stored in a non-volatile random access memory are often relatively high, as for example on the order of approximately 50 microseconds (μs) to read and approximately 500 μs to write. For many systems, the latency and semantics associated with accessing data stored in non-volatile random access memory renders the use of non-volatile random access memory to store data to replace DRAM based physical memory impractical.

### BRIEF DESCRIPTION OF THE DRAWINGS

The disclosure will be readily understood by the following detailed description in conjunction with the accompanying drawings in which:

FIG. 1A is a diagrammatic representation of a system that includes a physical memory and a non-volatile random-access memory, as for example NAND flash memory, in accordance with an embodiment.

FIG. 1B is a representation of accessing data stored in a NAND flash memory of a system that includes a physical memory and a NAND flash memory, e.g., system 100 of FIG. 1A, in accordance with an embodiment.

FIG. 2A is a diagrammatic representation of a system that includes a physical memory, a NAND flash memory, and a storage disk in accordance with a first embodiment.

FIG. 2B is a diagrammatic representation of a system that includes a physical memory, a NAND flash memory, and a storage disk in accordance with a second embodiment.

FIG. 3 is a process flow diagram which illustrates a method of processing a request for data in accordance with an embodiment.

FIG. 4 is a block diagram representation of a system which supports the use of a NAND flash memory which effectively serves substantially the same purpose as physical memory in accordance with an embodiment.

FIG. 5 is a process flow diagram which illustrates a method of moving data from a physical memory in accordance with an embodiment.

### DESCRIPTION OF EXAMPLE EMBODIMENTS

### General Overview

According to one aspect, a method includes obtaining a request for data, determining if the data is present in a physical volatile memory, and swapping the data from a non-volatile random access memory if it is determined that the data is not present in the physical volatile memory. The request is obtained by an overall system that includes the physical volatile memory and the non-volatile random access memory, and the overall system is configured to swap information from the physical volatile memory to the non-volatile random access memory. Swapping the data from the NVram includes swapping a page containing the data.

### Description

The access times associated with non-volatile random access memory such as a NAND flash memory may be relatively slow in comparison with the access times associated with a volatile memory such as a DRAM. DRAM may be accessed in sixty-four byte chunks, and an access time associated with accessing a line in DRAM may be in the range of approximately 60 nanoseconds (ns) to approximately 100 ns. NAND flash memory is generally accessed in blocks of approximately four kilobytes (kB) or approximately eight kB, and an access time associated with accessing a block of NAND flash memory may be on the order of approximately 60 microseconds (μs) to approximately 70 μs. However, the cost of non-volatile random access memory is generally significantly lower than the cost of volatile memory, and the power consumption of non-volatile random access memory is typically lower than the power consumption of volatile memory. Further, the density associated with a NAND flash memory may be higher than the density associated with a DRAM. For instance, while a single DRAM module may provide approximately eight Gigabytes of memory space, a single NAND flash memory dual in-line memory module (DIMM) may provide approximately 128 Gigabytes to approximately 512 Gigabytes.

A system which may incorporate non-volatile memory such as NAND flash memory in a memory hierarchy between DRAM and a storage disk may offer performance, cost, and power advantages. When a NAND flash memory may be accessed using substantially the same semantics as used to access DRAM, the cost, power consumption, and density associated with the NAND flash memory may be exploited.

By defining at least part of a cacheable physical address space as being composed of non-volatile memory, e.g., as including non-volatile random access memory, a NAND flash memory may effectively be utilized as physically addressable memory. In one embodiment, this may be accomplished by taking advantage of virtual memory architecture, and/or hypervisor architectures of computer systems, by changing the associated virtual mapping algorithms. Hypervisors virtualize the system memory and present a part of the virtualized memory as physical memory to guest operating systems. Subsequently, changes made to the virtual memory management system of the Hypervisor will not be visible to the guest OS, and as such no changes will be required in the guest OS. This enables unmodified guest operating system to be used. Such a design may enable relatively low power, relatively high density, and relatively inexpensive non-volatile memory to replace part of a DRAM physical memory in a computer system, offering cost, power, and density advantages. It should be appreciated that such a design may enable applications to be used on a system with essentially no changes, or specialized Application Programming Interfaces (APIs).

In one embodiment, a virtual machine manager such as a Hypervisor may be arranged to effectively cause a virtual machine to substantially treat non-volatile random access memory in a similar manner as volatile memory. That is, a virtual machine manager may essentially enable NAND flash memory to be accessed as if the NAND flash memory were a physically addressable memory, or an extension of the physical memory. Thus, a system that includes both a physical addressable memory, or a “physical memory,” of a relatively small size as well as an amount of NAND flash memory may effectively appear, and function, as if the system includes relatively large physical memory substantially without the cost, power consumption, and density issues that are typically associated with physical memory.

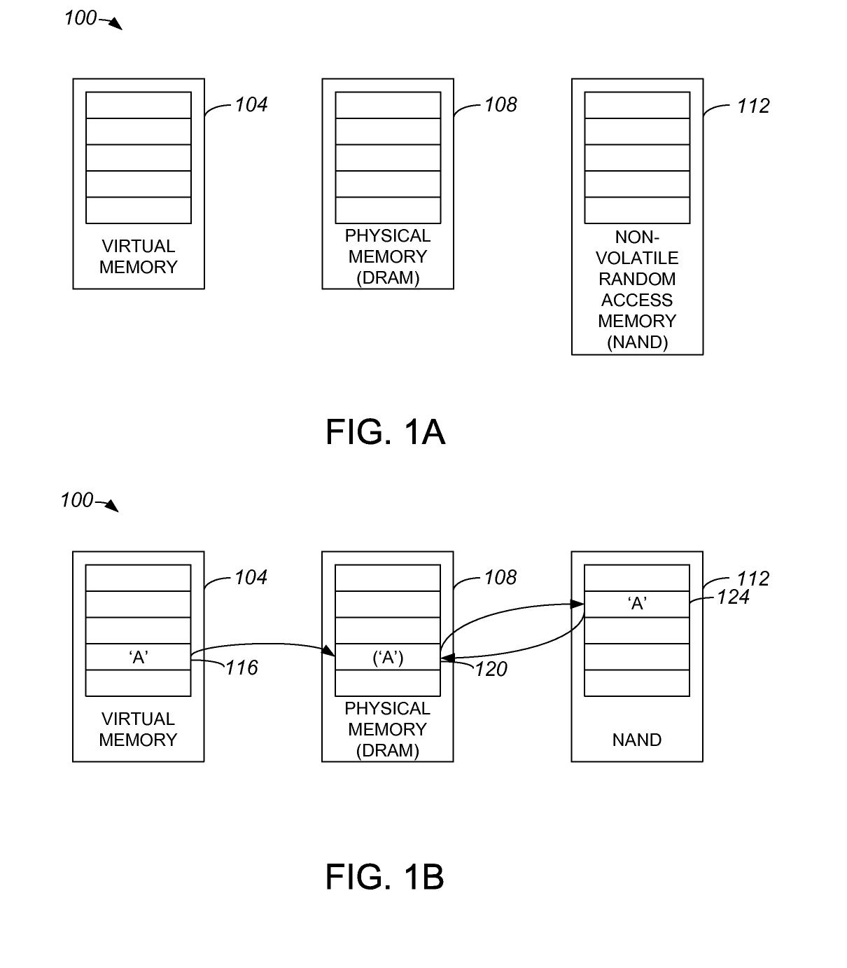

Referring initially to FIG. 1A, a system that includes a physical memory and a non-volatile random access memory that may be accessed using semantics typically used to access the physical memory will be described in accordance with an embodiment. A system 100 includes a virtual memory 104, a physical memory such as a DRAM 108, and a non-volatile random access memory such as a NAND flash memory 112. For ease of discussion, a physical memory will be referred to herein as a DRAM and a non-volatile random access memory will be referred to herein as a NAND flash memory, although it should be appreciated that a physical memory is not limited to being a DRAM and a non-volatile random access memory is not limited to being a NAND flash memory.

Virtual memory 104 may include a virtual address space that is substantially divided into pages, and includes page and/or translation tables (not shown) which may effectively translate virtual addresses into physical addresses associated with DRAM 108. Virtual memory 104 may inform system 100, e.g., a central processing unit (not shown) included in system 100, that system 100 includes more DRAM 108 than is actually present, as NAND flash memory 112 may effectively be counted as physical memory. In the described embodiment, NAND flash memory 112 is essentially an extension of DRAM 108, and may appear to be a physically addressable memory that is accessible as pages.

FIG. 1B is a representation of accessing data stored in NAND flash memory 112 in accordance with an embodiment. When a virtual address 116 is accessed within virtual memory 104, page translation tables (not shown) translate virtual address 116 to a corresponding physical address 120 associated with DRAM 108. In one embodiment, a page translation table (not shown) that has recently been accessed may be stored in DRAM 108 associated with system 100 to increase the efficiency with which the table may be accessed.

When physical address 120 contains the data corresponding to virtual address 116, the data is returned. However, as shown, physical address 120 does not contain the data corresponding to virtual address 116. The data expected in physical address 120 may have previously been pushed into, or otherwise stored on, NAND flash memory 112 in a block 124. Thus, NAND flash memory 112 may be accessed to obtain the data. The data is retrieved and placed into physical address 120. Once placed into physical address 120, the data may be returned.

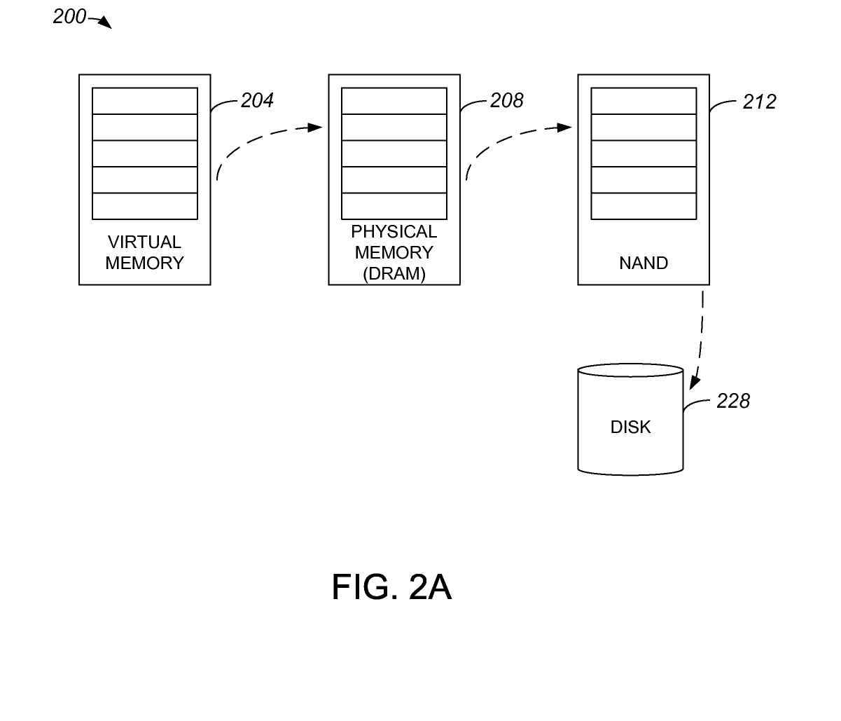

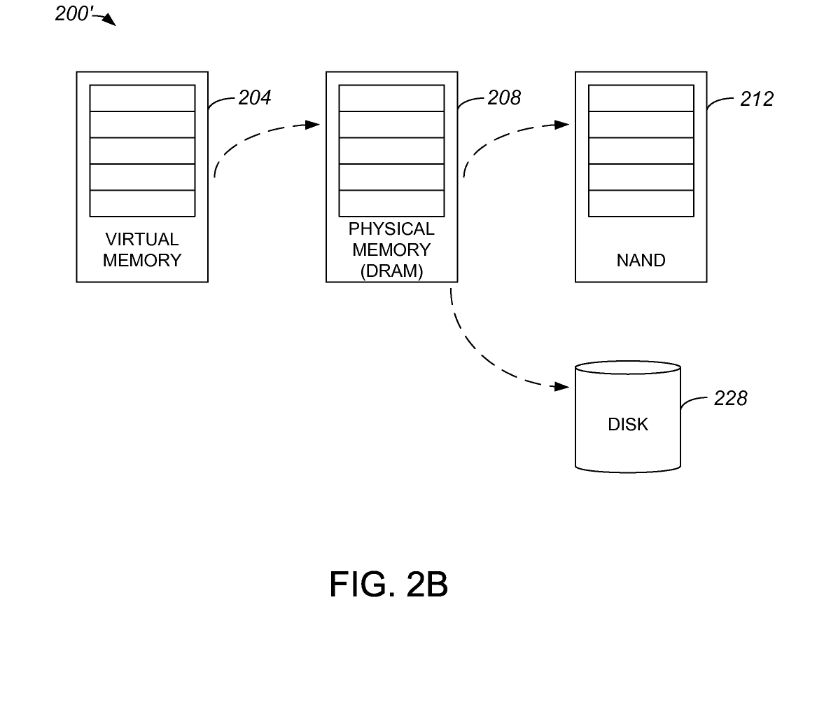

In addition to being arranged to cause data stored in a DRAM to be pushed onto a NAND flash memory when appropriate, a system may include a storage disk. In one embodiment, a NAND flash memory may be arranged to push data onto a storage disk, e.g., when the storage disk is arranged in series with the NAND flash memory. In another embodiment, a DRAM may either push data onto a NAND or directly onto a storage disk, e.g., when the storage disk is arranged in parallel with the NAND flash memory. FIG. 2A is a diagrammatic representation of a system that includes a physical memory, a NAND flash memory, and a storage disk that is arranged in series with the NAND flash memory in accordance with an embodiment. FIG. 2B is a diagrammatic representation of a system that includes a physical memory, a NAND flash memory, and a storage disk that is arranged in parallel with the NAND flash memory in accordance with an embodiment.

With reference to FIG. 2A, a system that includes a storage disk in series with a NAND flash memory will be described in accordance with an embodiment. A system 200 includes a virtual memory 204, a DRAM 208, a NAND flash memory 212, and a storage disk 228. The Hypervisor is configured to push DRAM 208 data onto NAND flash memory 212, and NAND flash memory 212 is configured to push data onto storage disk 228. In the described embodiment, DRAM 208 is not configured to be pushed data directly onto storage disk 228.

When data corresponding to a virtual address (not shown) on virtual memory 204 is not located in DRAM 208, the data may either be located in NAND flash memory 212 or in storage disk 228. If the data is located in NAND flash memory 212, the data may be put back into DRAM 208 such that the data may be returned. If, however, the data is located in storage disk 228, the data may be put back into NAND flash memory 212 and then put back into DRAM 208 prior to being returned, in one embodiment. It should be appreciated that data may instead be moved from storage disk 228 to DRAM 208, bypassing NAND flash memory 212 for some applications. Data may be substantially directly transferred from storage disk 228 to DRAM 208 and subsequently copied into NAND flash memory 212 to substantially minimize swap latency.

Referring next to FIG. 2B, a system that includes a storage disk in parallel with a NAND flash memory will be described in accordance with an embodiment. A system 200′ includes a virtual memory 204, a DRAM 208, a NAND flash memory 212, and a storage disk 228. The Hypervisor is configured to push DRAM 208 data substantially directly onto NAND flash memory 212, and substantially directly onto storage disk 228. For example, if a virtual memory system (not shown) is aware that data is unlikely to be used in the near future, the data may be stored substantially directly onto storage disk 228. When data corresponding to a virtual address (not shown) on virtual memory 204 is not located in DRAM 208, the data may either be located in NAND flash memory 212 or in storage disk 228. If the data is located in NAND flash memory 212, the data may be put back into DRAM 208 such that the data may be returned. Similarly, if the data is located in storage disk 228, the data may be put back into DRAM 218 such that the data may be returned.

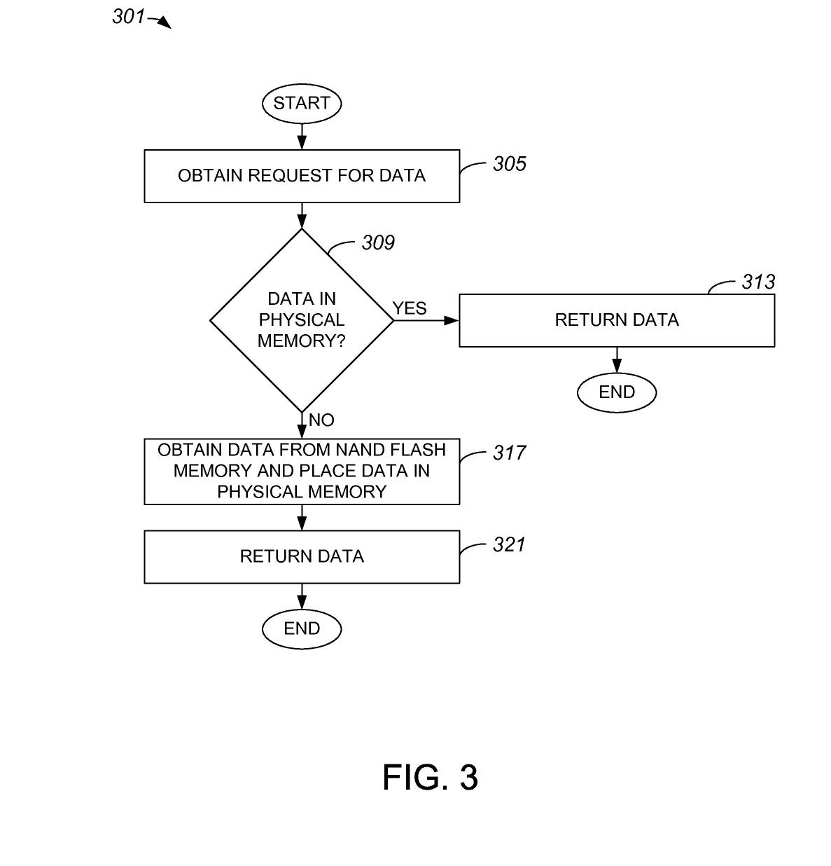

FIG. 3 is a process flow diagram which illustrates a method of processing a request for data received within an operating system or Hypervisor in accordance with an embodiment. A method 301 of processing a request for data begins at step 301 in which a request for data is obtained. The request for data may be obtained, for example, when a virtual memory address that is associated with data is accessed. Once the request for data is obtained, a determination is made in step 309 as to whether the data is present in physical memory, e.g., DRAM. Such a determination may be made, for example, by accessing a paging or translation table to identify a physical address within the DRAM that corresponds to the virtual memory address accessed as a result of the request for data. If it is determined that the data is in the DRAM, then the data is returned in step 313, and the method of processing a request for data is completed.

Alternatively, if it is determined in step 309 that the data is not present in the DRAM, the indication is that the data has previously been pushed from the DRAM onto a NAND flash memory. Accordingly, in step 317, the data is located in the NAND flash memory, and placed into the DRAM, i.e., at a physical address which corresponds to the virtual memory address. After the data is placed into the DRAM, the data is returned in step 321, and the method of processing a request for data is completed.

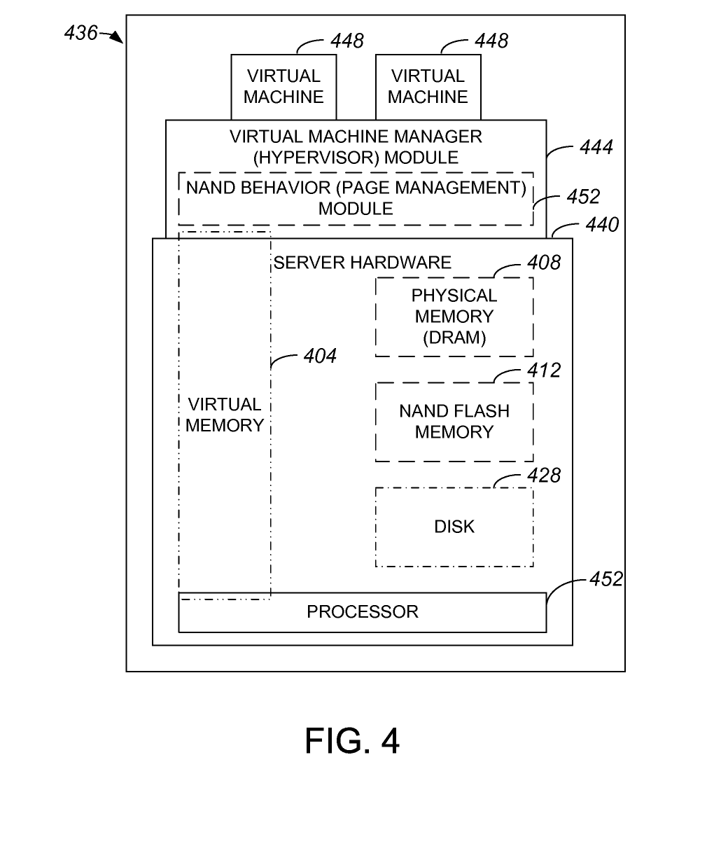

The functionality associated with allowing NAND flash memory to be accessed using substantially the same semantics as used to access DRAM may be provided in variety of different ways. For example, a paging system generally associated with an operating system may be changed to accommodate allowing NAND flash memory to be accessed using substantially the same semantics as used to access DRAM. In other words, a host operating system may implement changes to its virtual memory system such that NAND flash memory may be accessed using substantially the same semantics as used to access DRAM. Alternatively, a Hypervisor may be configured to support allowing NAND flash memory to be accessed using substantially the same semantics as used to access DRAM. FIG. 4 is a block diagram representation of a system which supports the use of a NAND flash memory which effectively serves substantially the same purpose as physical memory in accordance with an embodiment. A system 436 includes generally includes server hardware 440, a virtual machine manager module 444, and at least one virtual machine 448. Server hardware 440 includes a processor 452, a physical memory such as DRAM 408, and a NAND flash memory 412. Server hardware 440 may also optionally include a storage disk 428.

Virtual machine manager module 444, which may be a Hypervisor module, typically includes software logic and is configured with functionality that enables NAND flash memory 412 to behave or otherwise function as if NAND flash memory 412 is physical memory, e.g., a NAND flash memory behavior or NAND page management module 452. As will be appreciated by those skilled in the art, virtual machine manager module 444 provides a virtual operating platform and effectively manages the execution of virtual machines 448, e.g., virtual machines 448 associated with guest systems that host different operating systems. In one embodiment, a physical address space used by a guest system is a virtual address space associated with virtual machine manager 444, and address space management capabilities of virtual machine manager 444 are substantially orthogonal to other page management techniques of virtual machine manager 444. Virtual machine manager module 444 is arranged to create virtual machines 448, and may effectively hide server hardware 440 from virtual machines 448 such that virtual machines 448 may remain substantially the same even if components within server hardware 440 are changed.

As will be appreciated by those skilled in the art, virtual memory 404 is a software module, or logic embodied in a tangible medium. Virtual memory 404 may generally be a translation mechanism in a central processing unit, e.g., processor 452, and a page management algorithm in an operating system (not shown) or virtual machine manager module 444. In one embodiment, at least one virtual machine 448 is arranged to substantially execute a simulated processor architecture, in cooperation with virtual machine manager module 444, that enables NAND flash memory 412 to be accessed using substantially the same semantics used to access DRAM 408.

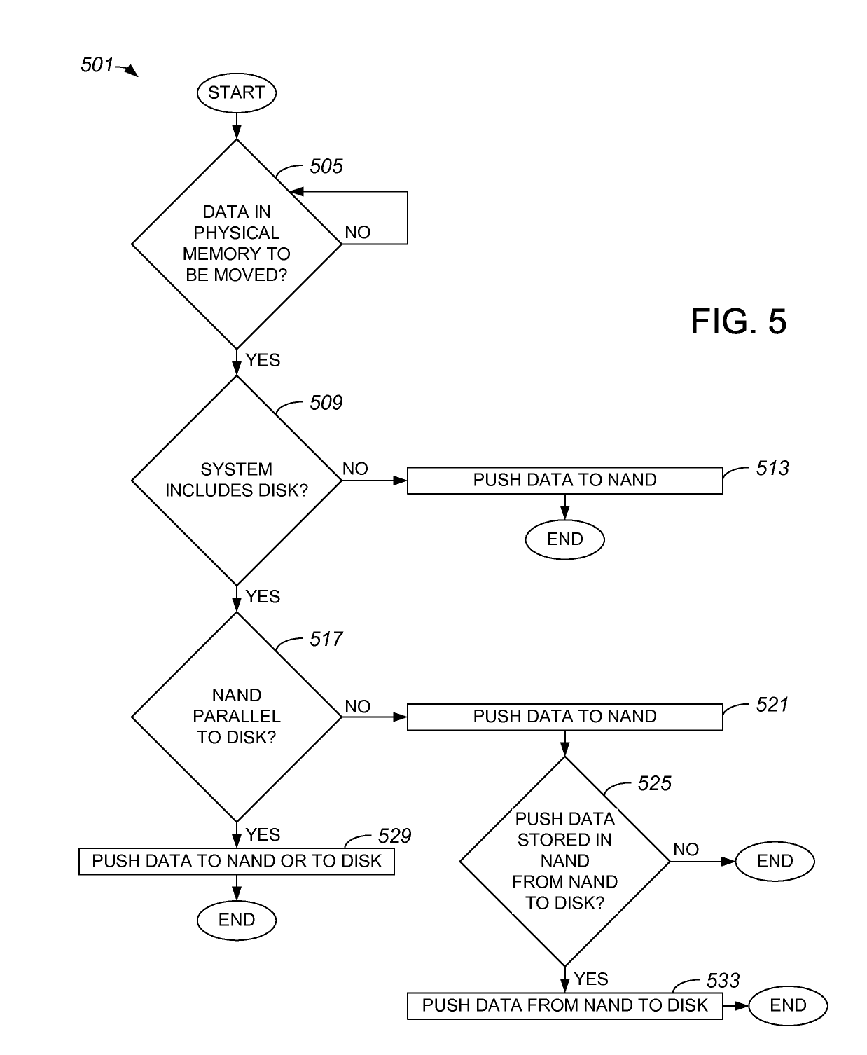

FIG. 5 is a process flow diagram which illustrates a method of moving data from a physical memory such as a DRAM in accordance with an embodiment. A method 501 of moving data from a physical memory such as a DRAM begins at step 505 in which it is determined if data that is stored in DRAM, e.g., as an active page, is to be moved. Such a determination may be based on any suitable factors. For example, such a determination may be based on a number of well-known algorithms that are currently used in virtual memory managers of operating systems and Hypervisors, and typically involve estimating the likelihood that a page may be required in the substantially immediate future relative to other pages in memory. In general, an OS or a Hypervisor maintains a free-list of pages that may be used for such a purpose as a background process. As a result, latency associated with allocating a page may be substantially minimized. When it is determined in step 505 that data is to be moved from physical memory, a determination is made in step 509 as to whether an overall system includes a storage disk. That is, it is determined whether the overall system includes a storage disk in addition to a NAND flash memory. If it is determined that the overall system does not include a storage disk, the indication is that data is to be moved to the NAND flash memory. As such, data is pushed to the NAND flash memory in step 513, and the process of moving data from a physical memory is completed.

Alternatively, if it is determined in step 509 that the overall system includes a storage disk, then process flow moves to step 517 in which it is determined whether the NAND flash memory is arranged in parallel to the storage disk, as for example as shown in FIG. 2B. If it is determined that the NAND flash memory is not parallel to the storage disk, then the implication is that the storage disk is in series with or otherwise chained with the NAND flash memory, e.g., as shown in FIG. 2A. Accordingly, in step 521, the data is pushed from the physical memory to the NAND flash memory.

After data is pushed to the NAND flash memory in step 521, it is determined in step 525 whether to push the same data from the NAND flash memory to the storage disk. In general, a freelist of NAND pages may be maintained, much like the case for physical memory pages, as a background process to move inactive pages from NAND flash memory to the storage disk. As a result, the need to wait for the NAND page to be moved at the time the page request is made may be substantially obviated, and the latency to service a page request may be substantially minimized. If it is determined that the data stored in the NAND flash memory is not to be moved to the storage disk, then the process of moving data from a physical memory is completed.

Alternatively, if it is determined in step 525 that the data is to be pushed from the NAND flash memory to the storage disk, then the data is pushed from the NAND flash memory to the storage disk in step 533. Once the data is present on the storage disk, the process of moving data from a physical memory is completed.

Returning to step 517 and the determination of whether the NAND flash memory is parallel to the storage disk, if it is determined that the NAND flash memory is parallel to the storage disk, process flow moves to step 529 in which the data is pushed either to the NAND flash memory or to the storage disk. In one embodiment, the determination of whether the data is pushed to the NAND flash memory or the storage disk may be based at least in part upon the amount of available space remaining in the NAND flash memory. Upon pushing the data either to the NAND flash memory or to the storage disk, the process of moving data from a physical memory is completed.

System memory data is generally compressible. Compressing flash-based memory data, e.g., data stored in a NAND flash memory, may reduce latency associated with time needed to read data and improve the lifetime of flash-based memory, e.g., by reducing inter-page interference due to less data being written. Compression and decompression of data stored in system memory may be performed substantially in real-time, e.g., on-the-fly. In one embodiment, data may be read from and written to flash-based memory in page-sized chunks. It should be appreciated that a page table entry may provide information regarding the type of compression, if any, used on a particular data type.

Although only a few embodiments have been described in this disclosure, it should be understood that the disclosure may be embodied in many other specific forms without departing from the spirit or the scope of the present disclosure. By way of example, while a non-volatile random access memory has generally been described as being a NAND flash memory, it should be appreciated that a non-volatile random access memory is not limited to being a NAND flash memory. Other suitable non-volatile random access memories which may be used in lieu of, or in addition to, a NAND flash memory is a phase change memory. A phase change memory generally supports random read and write capabilities, and allows for in-situ updating.

Wear leveling and garbage collection are generally background process, as will be understood by those skilled in the art. Because valid pages in a non-volatile random access memory such as a NAND flash memory are not generally active pages within an overall virtual machine system, wear leveling and garbage collection performed with respect to the non-volatile random access memory generally do not have a significant impact on overall system processes.

The embodiments described above generally relate to utilizing relatively slow and dense non-volatile memory to replace and/or to augment physical memory. It should be appreciated that, in some instances, the non-volatile properties of some or all of added memory may be substantially exploited. To take advantage of non-volatile properties, a definition of which pages are non-volatile may be needed, and a determination may be made as to when a page has been transferred to volatile memory, and when a page has been transferred from volatile memory and non-volatile memory. In addition, mechanisms may be implemented to move a page from volatile memory to non-volatile memory.

A system has generally been described as including some amount of NAND flash memory that is utilized in conjunction with some amount of physical memory such as DRAM. That is, a system is generally configured with a mix of DRAM and non-volatile random access memory such as NAND flash memory. The amount of DRAM and the amount of non-volatile random access memory to include in a system may vary widely, and may depend upon factors including, but not limited to including, price, desired performance, and power requirements.

The embodiments may be implemented as hardware and/or software logic embodied in a tangible medium that, when executed, is operable to perform the various methods and processes described above. That is, the logic may be embodied as physical arrangements, modules, or components. Software logic may generally be executed by a central processing unit or a processor. A tangible medium may be substantially any suitable physical, computer-readable medium that is capable of storing logic which may be executed, e.g., by a computing system, to perform methods and functions associated with the embodiments. Such computer-readable media may include, but are not limited to including, physical storage and/or memory devices. Executable logic may include code devices, computer program code, and/or executable computer commands or instructions. Such executable logic may be executed using a processing arrangement that includes any number of processors.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure.

What is claimed is:

1. A method comprising:
obtaining a request for data, the request being obtained by a system, the system including a physical volatile memory and a non-volatile random access memory (NVram), wherein the system is configured to swap information from the physical volatile memory to the NVram;
determining if the data is present in the physical volatile memory; and
swapping the data from the NVram if it is determined that the data is not present in the physical memory of the system, wherein swapping the data includes swapping a page containing the data.

2. The method of claim 1 wherein if it is determined that the data is present in the physical volatile memory, the data is accessed in the physical volatile memory and provided in response to the request.

3. The method of claim 1 further including:
providing the data obtained from the NVram in response to the request after swapping the data from the NVram, wherein swapping the data from the NVram is performed by an operating system page management system.

4. The method of claim 3 wherein swapping the data from the NVram includes accessing the data in the NVram and storing the data in the physical volatile memory after accessing the data in the NVram, and providing the data obtained from the NVram in response to the request includes providing the data from the physical volatile memory after storing the data in the physical memory.

5. The method of claim 1 wherein the system further includes a virtual memory, and determining if the data is present in the physical volatile memory includes identifying an indication present in the virtual memory, the indication being arranged to identify the data, and utilizing the indication to determine if the data is present in the physical volatile memory.

6. The method of claim 1 wherein the system further includes a storage disk, the method further including:
determining if the data is present in the NVram, wherein the data is obtained from the NVram if it is determined that the data is not present in the physical volatile memory of the system and if it is determined that the data is present in the NVram, wherein if it is determined that the data is not present in the NVram, the data is obtained from the storage disk.

7. The method of claim 1 wherein the data is initially stored in the physical volatile memory, the further including:
flushing the data from the physical volatile memory to the NVram before obtaining the request for the data.

8. A non-transitory computer-readable medium comprising computer program code, the computer program code, when executed, configured to:
obtain a request for data, the request being obtained by a system, the system including a physical volatile memory and a non-volatile random access memory (NVram), wherein the system is configured to swap information from the physical volatile memory to the NVram;
determine if the data is present in the physical volatile memory; and
swap the data from the NVram if it is determined that the data is not present in the physical volatile memory of the system.

9. The computer program code of claim 8 wherein if it is determined that the data is present in the physical volatile memory, the data is accessed in the physical volatile memory and provided in response to the request.

10. The computer program code of claim 8 further configured to:
provide the data obtained from the NVram in response to the request after obtaining the data from the NVram.

11. The computer program code of claim 10 wherein the computer program code configured to swap the data from the NVram is further configured to access the data in the NVram and to store the data in the physical volatile memory, and the computer program code configured to provide the data obtained from the NVram in response to the request is further configured to provide the data from the physical volatile memory after the data is stored in the physical volatile memory.

12. The computer program code of claim 8 wherein the system further includes a virtual memory, and the computer code configured to determine if the data is present in the physical volatile memory is further configured to identify an indication present in the virtual memory, the indication being arranged to identify the data, and to utilize the indication to determine if the data is present in the physical volatile memory.

13. The computer program code of claim 8 wherein the system further includes a storage disk, the computer program code further being configured to:
determine if the data is present in the NVram, wherein the data is obtained from the NVram if it is determined that the data is not present in the physical volatile memory of the system and if it is determined that the data is present in the NVram, wherein if it is determined that the data is not present in the NVram, the data is obtained from the storage disk.

14. The computer program code of claim 8 wherein the data is initially stored in the physical volatile memory, the computer program code further being configured to flush the data from the physical volatile memory to the NVram before the request for the data is obtained.

15. A system comprising:
a physical volatile memory;
a non-volatile random access memory (NVram);
means for obtaining a request for data;
means for determining if the data is present in the physical volatile memory; and
means for obtaining the data from the NVram if it is determined that the data is not present in the physical volatile memory of the system.

16. An apparatus comprising:
server hardware, the server hardware including a processor, at least a virtual memory, a physically addressable memory, and a non-volatile random access memory;
a virtual machine; and
a virtual machine manager module, the virtual machine manager module being configured to cooperate with the virtual machine to access the physically addressable memory using a first set of semantics associated with the physically addressable memory, the virtual machine manager module further being configured to cooperate with the virtual machine to enable the non-volatile random access memory to be accessed using the first set of semantics associated with the physically addressable memory.

17. The apparatus of claim 16 wherein the virtual machine manager module is a Hypervisor module, the physically addressable memory is a DRAM, and the non-volatile random access memory is a NAND flash memory.

18. The apparatus of claim 16 wherein the virtual machine manager module and the virtual machine are arranged to cooperate to move data stored in the physically addressable memory to the non-volatile random access memory.

19. The apparatus of claim 18 wherein the virtual machine manager module and the virtual machine are arranged to cooperate to move the data by causing the data to be flushed from an active page associated with the physically addressable memory into an active page in the non-volatile random access memory.

20. The apparatus of claim 18 wherein the virtual machine manager module and the virtual machine are arranged to cooperate to obtain a request for the data and to move the data from the non-volatile random access memory back to the physical memory in response to the request for the data.
